(19) United States
(12) Patent Application Publication
(10) Pub. No.: US 2024/0073783 A1
(43) Pub. Date: Feb. 29, 2024

(54) BLE LINK CLUSTER CONTROL AND MANAGEMENT

(71) Applicant: TEXAS INSTRUMENTS INCORPORATED, Dallas, TX (US)

(72) Inventors: Yaron ALPERT, Hod Hasharon (IL); Yaniv WEIZMAN, Tel Aviv Jaffa (IL); Ariton E. XHAFA, Plano, TX (US)

(21) Appl. No.: 17/899,526

(22) Filed: Aug. 30, 2022

(51) Int. Cl. H04W 40/32; H04L 1/00; H04W 52/02; H04W 52/36

(52) U.S. Cl. CPC H04W 40/32; H04L 1/0003; H04W 52/0274; H04W 52/367

(57) ABSTRACT

In an example, a method includes connecting a first BLUETOOTH device to a second BLUETOOTH device via one or more links within a link cluster. The method also includes receiving a request at the first BLUETOOTH device from the second BLUETOOTH device to change one or more link connection parameters of a link within the link cluster. The method includes, responsive to receiving the request, changing the link connection parameter of the link within the link cluster.

### CROSS-REFERENCE TO RELATED APPLICATIONS

The present application is related to Attorney Docket Number T101240, U.S. application Ser. No. 17/899,518, filed concurrently herewith, which is titled “BLE Link Cluster Discovery, Establishing, and Termination,” and is hereby incorporated herein by reference in its entirety.

### BACKGROUND

BLUETOOTH low energy (BLE) is a wireless communication technology useful for various applications and devices, such as in healthcare, fitness, security, home entertainment, and communication devices. The BLE communication technology provides for lower power consumption of the communication devices in comparison to BLUETOOTH or other wireless communication technologies, while also maintaining a similar wireless communication range and coverage. The reduced power consumption of the communication devices may be provided by a simpler modulation scheme in comparison to the other wireless communication technologies. The BLE communication technology is based on a BLE communication standard supported by various operating systems (OS), including ANDROID, IOS, WINDOWS, MACOS, LINUX, and other OS to operate the communication devices.

### SUMMARY

In accordance with at least one example of the description, a method includes connecting a first BLUETOOTH device to a second BLUETOOTH device via one or more links within a link cluster. The method also includes receiving a request at the first BLUETOOTH device from the second BLUETOOTH device to change one or more link connection parameters of a link within the link cluster. The method includes, responsive to receiving the request, changing the link connection parameter of the link within the link cluster.

In accordance with at least one example of the description, a method includes connecting a first BLUETOOTH device to a second BLUETOOTH device via one or more links within a link cluster. The method also includes placing the first BLUETOOTH device in a power save mode, where the first BLUETOOTH device suspends one or more of the links within the link cluster in the power save mode. The method includes modifying a connection parameter of a link within the link cluster via an active link in the link cluster. The method also includes exiting the power save mode and entering an active mode.

### BRIEF DESCRIPTION OF THE DRAWINGS

FIG. 1 is a block diagram of a processing and communication system in accordance with various examples.

FIG. 2 is a BLUETOOTH device (e.g., a BLE device) communicatively coupled to one or more other devices in accordance with various examples.

FIG. 3 is a block diagram of a BLE network in accordance with various examples.

FIG. 4A is a diagram of a network with a link cluster between two BLUETOOTH devices in accordance with various examples.

FIG. 4B is a diagram of a network with a link cluster between three BLUETOOTH devices in accordance with various examples.

FIG. 4C is a diagram of a network with a link cluster between three BLUETOOTH devices in accordance with various examples.

FIG. 5 is a block diagram of a state machine for a BLE device in accordance with various examples.

FIG. 6A is a discovery phase flow for link clusters in accordance with various examples.

FIGS. 6B and 6C are timing diagrams of link cluster discovery signaling in accordance with various examples.

FIG. 7 is a connecting and termination phase flow for link clusters in accordance with various examples.

FIG. 8 is a generic attribute profile flow for a link cluster in accordance with various examples.

FIG. 9 is a flow diagram of a method for establishing a link cluster in accordance with various examples.

FIG. 10 is a flow diagram of a method for controlling a link cluster with a generic attributes profile in accordance with various examples.

FIG. 11 is a procedure flow for link cluster coordination in accordance with various examples.

FIG. 12 is a procedure flow for link cluster control and management in accordance with various examples.

FIG. 13 is a flow diagram of a method for managing link cluster connection parameters in accordance with various examples.

FIG. 14 is a flow diagram of a method for power management in a link cluster in accordance with various examples.

The same reference numbers or other reference designators are used in the drawings to designate the same or similar (functionally and/or structurally) features.

### DETAILED DESCRIPTION

The BLUETOOTH (BT) Low Energy (BLE) standard defines a standard hierarchy of components. The hierarchy includes a BLE controller and a BLE host. Some examples may include a BLE PHY (physical) layer and a radio frequency (RF) frontend. On top of the BLE controller and BLE host resides the BLE application. The BLE controller handles all tasks required for a connection to stay active. A unicast BLE connection consists of two devices. BLE devices communicate at constant intervals (i.e. connection events) on channels known as a BLE data channel set. During a connection event, a device called a central handles one or more connection events by transmitting and receiving a packet(s) to a device called a peripheral. According to the BLE communication standard in the Bluetooth Core Specification Verification 5.3, which is incorporated herein by reference, data transfers may be carried over links or data channel sets, which are connections established between communication devices to exchange data in the form of messages or packets. Each data channel within the channel set has a unique band between 2.4 gigahertz (GHz) and 2.4835 GHz and thus each of those channels has unique characteristics. A link between two devices is a superset of connection events, where a connection event is each instance of communication between the two devices.

The current BLUETOOTH standard can support multiple centrals and multiple peripherals operating simultaneously. A central can connect to multiple peripherals, without connection events overlapping, in one case. In another case, a peripheral can simultaneously, without connection events overlapping, connect to multiple centrals. Connections are established based on peripheral advertising and central scanning. If a connection is established, the peripheral advertising is renewed to enable the peripheral to establish an additional connection with another central.

The current BLE standard limits a central from establishing more than one link to a single peripheral. In examples herein, link clusters are described, which are collections of two or more links between two BLE devices. Link clusters include two or more links that have a dependency or coordination between the links. Link clusters may include a collection of links between any number of devices. Link cluster discovery, establishment, and termination procedures are described herein. These procedures may be based on over-the-air signal exchange or over host controller interface (HCI) signal exchange. In other examples herein, link cluster management and control procedures are described. Coordination procedures may be useful to set or update the connection parameters of a specific link or of several coupled links within the link cluster. Link cluster signaling exchanges may be conducted over one link in a link cluster. In one example, link cluster signaling may support link cluster power management, where a power level per channel within the channel set may be limited. Link clusters allow a BLE system as described herein to optimize power consumption of link cluster devices, reduce latency, and increase system level throughput in some examples.

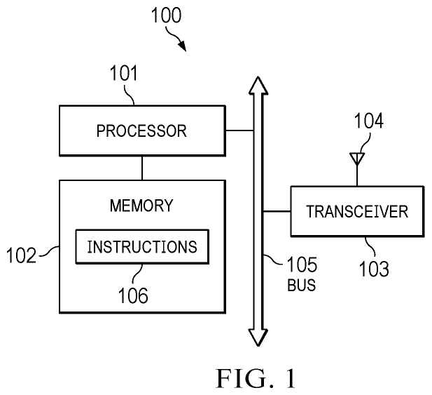

FIG. 1 is a block diagram of a processing and communication system 100 useful for processing and exchanging data, in accordance with various examples herein. The processing and communication system 100 may be a BLE device that is capable of establishing a connection to transmit and receive messages or packets in accordance with a BLE communication standard. For example, the processing and communication system 100 may be a central device, such as a router or a BLE hub, a computer device or a smartphone, or may be a peripheral device such as an Internet of Things (IoT) device, a sensor or other BLE device capable of establishing a connection with a second BLE device or a network, such as the Internet. In some examples, the processing and communication system 100 may be a system on a chip (SoC), an electronic circuit board or a computer card of a BLE device.

The processing and communication system 100 includes hardware components for establishing a connection and transmitting and receiving data in accordance with the BLE communication standard. As shown in FIG. 1, the processing and communication system 100 may include one or more processors 101 and one or more memories 102. The processing and communication system 100 may also include one or more transceivers 103 and one or more antennas 104 for establishing wireless connections. These components may be coupled through a bus 105, or in any other suitable manner. In FIG. 1, an example in which the components are coupled through a bus 105 is shown.

The processor 101 is configured to read and execute computer-readable instructions. For example, the processor 101 is configured to invoke and execute instructions in a program stored in the memory 102, including instructions 106. Responsive to the processor 101 transmitting data, the processor 101 drives or controls the transceiver 103 to perform the transmitting. The processor 101 also drives or controls the transceiver 103 to perform receiving, responsive to the processor 101 receiving data. Therefore, the processor 101 may be considered as a control center for performing the transmitting or receiving of data and the transceiver 103 is an executor for performing the transmitting and receiving operations.

In some examples, the memory 102 is coupled to the processor 101 through the bus 105. In other examples, the memory 102 is integrated with the processor 101. The memory 102 is configured to store various software programs and/or multiple groups of instructions, including the instructions 106. The memory 102 may include one or more storage devices. For example, the memory 102 includes a high-speed random-access memory and/or may include a nonvolatile memory such as one or more disk storage devices, a flash memory, another nonvolatile solid-state storage device, or a pseudo-static random-access memory (PSRAM). The memory 102 may store an OS such as ANDROID, IOS, WINDOWS or LINUX. The memory 102 may further store a network communications program. The network communications program is useful for performing communications with one or more attached devices, one or more user devices, or one or more network devices. The memory 102 may further store a user interface program. The user interface program displays content of an application through a graphical interface and receives data or an operation performed by a user on the application via an input control such as a menu, a dialog box or a physical input device (not shown). The memory 102 is configured to store the instructions 106 for implementing the various methods and processes provided in accordance with the various examples of this description.

The transceiver 103 includes a transmitter and a receiver. The transceiver 103 is configured to transmit one or more signals that is provided by the processor 101. The transceiver 103 is also configured to receive one or more signals from other devices or equipment. In this example, the transceiver 103 may be considered a wireless transceiver. The antenna 104 may be configured to enable the exchanging of wireless communication signals between the transceiver 103 and a network or another system or device.

The processing and communication system 100 may also include another communication component such as a Global Positioning System (GPS) module, cellular module, a BLUETOOTH or BLE module, Zigbee module, Long Term Evolution (LTE), LTE-Machine Type Communication (LTE-M), Narrow Band LTE (NB-LTE), Sub-Gigahertz Communication (sub1G), Wi-SUN, IEEE 802.15.4, or a Wireless Fidelity (WI-FI) module. The processing and communication system 100 may also support another wireless communication signal such as a satellite signal or a short-wave signal. The processing and communication system 100 may also be provided with a wired network interface or a local area network (LAN) interface to support wired communication.

In various examples, the processing and communication system 100 may further include an input/output interface (not shown) for enabling communications between the processing and communication system 100 and one or more input/output devices (not shown). Examples of the input/output devices include an audio input/output device, a key input device, a display and the like. The input/output devices are configured to implement interaction between the processing and communication system 100 and a user or an external environment. The input/output device may further include a camera, a touchscreen, a sensor, and the like. The input/output device communicates with the processor 101 through a user interface.

The processing and communication system 100 shown in FIG. 1 is an example of a processing and communication system or device. During actual application, the processing and communication system 100 may include more or fewer components. The processing and communication system 100 may be part of a BLE device that is connected to other BLE devices.

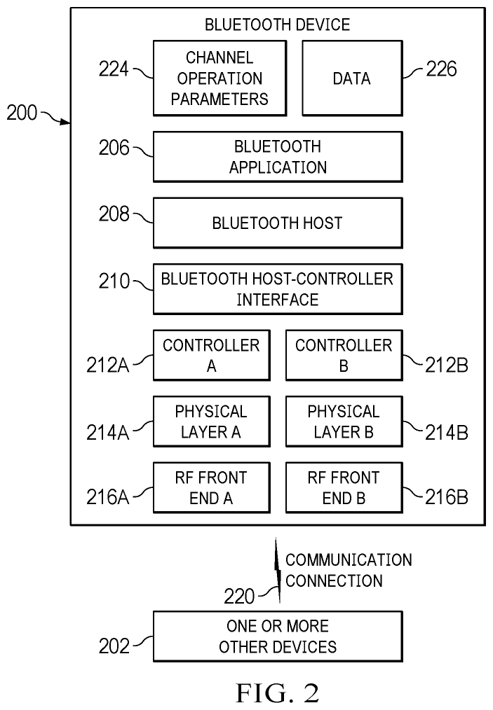

FIG. 2 depicts an example of a BLUETOOTH device 200 (e.g., a BLE device) communicatively coupled to one or more other devices 202 via communication connection 220 in accordance with various examples herein. Communication connection 220 could be a channel as described herein. The one or more other devices 202 include any device configured to communicate with the BLUETOOTH device 200. The communication connection 220 may be any connection medium, link, link cluster, channel set(s), channel(s), or connection event(s), such as a wireless communication connection. In some example, communication connection 220 is a link cluster that includes two or more links.

The BLUETOOTH device 200 includes a BLUETOOTH application 206, a BLUETOOTH host 208, a BLUETOOTH host-controller interface 210, two BLUETOOTH controllers 212A and 212B, two BLUETOOTH PHY layers 214A and 214B, and two RF frontends 216A and 216B. BLUETOOTH device 200 may include two or more, separate PHY layers joined by a single interface to a single logical link control layer and a single media access control layer. BLUETOOTH PHY layer 214A and RF frontend 216A may be configured to form a first link with another device, and BLUETOOTH PHY layer 214B and RF frontend 216B may be configured to form a second link with that other device, where the first and second links are separate links. In some examples, each of RF frontends 216A and 216B may include one or more antennas and other transceiver circuitry for communicating with another device. Other examples may include a single controller 212 with multiple BLUETOOTH PHY layers 214, a single controller 212 with a single BLUETOOTH PHY layer 214 and multiple RF frontends 216, or a single controller 212 with a single BLUETOOTH PHY layer 214 and a single RF frontend 216.

In some examples, the BLUETOOTH device 200 of FIG. 2 corresponds to, includes the components of, and is configured as described above with reference to communication system 100 of FIG. 1. Thus, references herein to the BLUETOOTH device 200 of FIG. 2 may be considered as references to the communication system 100 of FIG. 1. In some examples, the one or more other devices 202 may correspond to, include the components of, and be configured as described above with reference to communication system 100 of FIG. 1. In some examples, the one or more other devices 202 may include similar components as BLUETOOTH device 200.

The BLUETOOTH device 200 is configured to provide the BLUETOOTH controller 212 with link cluster channel operation parameters 224. Data 226 may include any data related to communication between devices, such as performance indicators related to a channel within the channel set (e.g., power consumption, average and peak throughput, modem characteristic, modulation coding scheme (MCS), packet level limitations, responsiveness, etc.). Example details of selecting and changing channels can be found in commonly assigned U.S. patent application Ser. No. 17/828,225, entitled “Frequency Change During Connection Event,” filed on May 31, 2022, which is incorporated herein by reference in its entirety.

In some examples, BLUETOOTH device 200 may use advertising procedures to share connection parameters for a link within a link cluster and coordinate connection events between two or more devices. The connection parameters may include limitations or capabilities of the BLUETOOTH device 200. The device that advertises may be referred to as a broadcaster in examples herein. Other devices 202 (such as a second BLUETOOTH device 202 and/or a third BLUETOOTH device 202) may receive these advertisements and negotiate a communication connection with BLUETOOTH device 200. The device that receives the advertisement may be referred to as a scanner herein. The communication connection may be one or more links within a link cluster. After the link is established, the broadcaster may be referred to as a peripheral device, and the scanner may be referred to as a central device. In some examples, other devices 202 may accept the advertised connection parameters for a link within the link cluster, or may alter the connection parameters and then negotiate a communication connection with BLUETOOTH device 200. By using advertising procedures, communication connections may be made faster or with lower power use than other procedures.

In examples herein, a BLUETOOTH device 200 may engage in discovery, establishment, management, and termination of links within link clusters. The connection parameters of one or more links within a link cluster may be selected, negotiated, and updated as described herein. One or more of the links within a link cluster may be terminated in some examples. The operation settings (channel set, modem characteristic, power management, power level, duration, anchor point, etc.) of one or more links within a link cluster may be modified as described herein. Signaling operations in some examples may set or update parameters of a link or multiple links in a link cluster, such as PHY (physical) parameters, channel map and channel selection, encryption parameters, modem characteristic, MCS, packet level limitations, connection event limitations, and power management limitations (e.g., transmit power limitations). Links within a link cluster have an awareness or level of coordination between one another to form the link cluster. Each device may manage and coordinate its own links to effectively manage these links as part of link cluster.

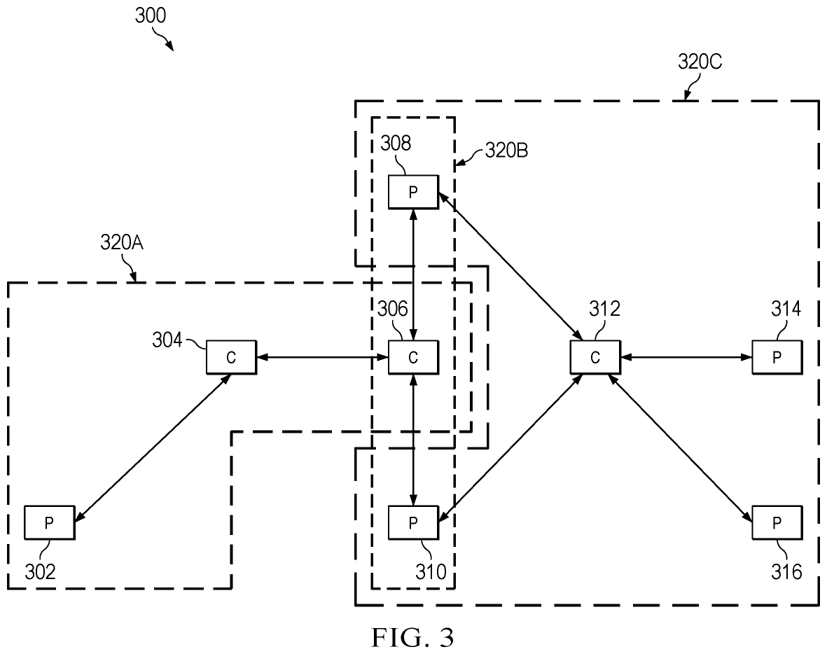

FIG. 3 is a block diagram of a BLE network 300 in accordance with various examples herein. BLE network 300 includes devices 302, 304, 306, 308, 310, 312, 314, and 316. In this example, devices 304, 306, and 312 are central devices, while devices 302, 308, 310, 314, and 316 are peripheral devices. BLE network 300 also includes sub-networks 320A, 320B, and 320C. Sub-network 320A includes devices 302, 304, and 306. Sub-network 320B includes devices 306, 308, and 310. Sub-network 320C includes devices 308, 310, 312, 314, and 316.

BLE network 300 is a multi-peripheral multi-central network in one example. In multi-central mode, more than one central may be connected to a single peripheral device. As an example, peripheral device 308 is connected to both central device 306 and central device 312. In multi-peripheral mode, more than one peripheral may be connected to a multi-central device. As an example, peripheral devices 308 and 310 are connected to central device 306. In BLE network 300, any of the devices may be connected to any other device using a link cluster of two or more links. In other words, any of the connections shown in FIG. 3 may be a multi-link connection (i.e., a link cluster) between two devices.

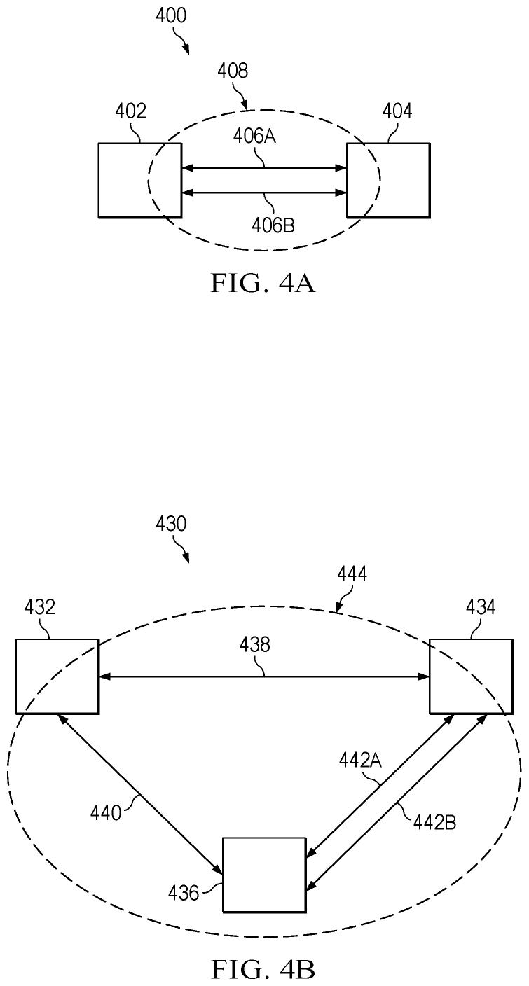

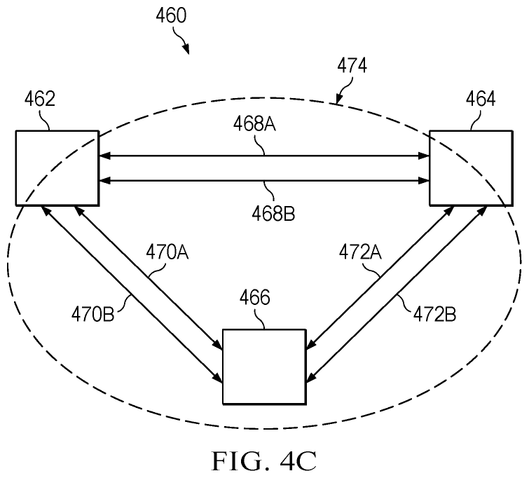

FIG. 4A is a diagram of a network 400 with a link cluster between two BLUETOOTH devices in accordance with various examples herein. Network 400 includes device 402 and device 404. Device 402 may be a central device and device 404 may be a peripheral device in one example. Device 402 is connected to device 404 via links 406A and 406B. Links 406A and 406B form link cluster 408 in this example. In other examples, link cluster 408 may include more than two links. Links 406A and 406B in link cluster 408 have an awareness or level of coordination between one another to form the link cluster. Devices 402 and 404 may communicate via multiple links 406A and 406B by offsetting the communications in frequency and/or time. For example, device 402 can send a first packet over link 406A by encoding the first packet in a first frequency channel, and device 402 can send a second packet over link 406B by encoding the second packet in a second frequency channel. Device 402 may be configured to transmit the first and second packets simultaneously, at partially overlapping times, or at fully offset times.

Network 400 may transmit data between device 402 and device 404 using any suitable technique. One technique is synchronous duplicate mode, where the same data is transmitted on link 406A and link 406B. In duplicate mode, the transmitter sends copies of each frame over multiple links. In other examples, more than two links may connect device 402 and device 404. In duplicate mode, a receiver may obtain a frame on a first link and then drop copies of the frame that are received on subsequent links. Duplicate mode increases robustness of the network. Another technique is joint mode. In joint mode, transmitted frames are sent over multiple available links, but copies of frames are not sent. Joint mode reduces transmission latency. Examples described herein may use either or both modes.

FIG. 4B is a network 430 with a link cluster between three BLUETOOTH devices in accordance with various examples herein. Network 430 includes devices 432, 434, and 436. Each of device 432, 434, or 436 may be either a central device or a peripheral device in various examples. In this example, device 432 is connected to device 434 via link 438. Device 432 is connected to device 436 via link 440. Device 434 is connected to device 436 via links 442A and 442B. Network 430 also includes link cluster 444. Devices 432, 434, and 436 may coordinate the links 438, 440, 442A, and 442B to create link cluster 444. Each device may coordinate its own links to effectively manage these links as part of link cluster 444. In examples herein, additional links may be added between any two devices. Network 430 is an example of a link cluster with more than two BLUETOOTH devices.

FIG. 4C is a network 460 with a link cluster between three BLUETOOTH devices in accordance with various examples herein. Network 460 includes devices 462, 464, and 466. Each of device 462, 464, or 466 may be either a central device or a peripheral device in various examples. In this example, device 462 is connected to device 464 via links 468A and 468B. Device 462 is connected to device 466 via links 470A and 470B. Device 464 is connected to device 466 via links 472A and 472B. Network 460 also includes link cluster 474. Devices 462, 464, and 466 may coordinate the links 468A, 468B, 470A, 470B, 472A, and 472B to create link cluster 474. Each device may coordinate its own links to effectively manage these links as part of link cluster 474. In examples herein, additional links may be added between any two devices. In other examples, the link cluster may include any subset of links 468A, 468B, 470A, 470B, 472A, and 472B.

Examples herein provide for a system and method for link cluster discovery, establishing, and termination. Examples herein may include link cluster detection, discovery, establishment, and termination procedures that coordinate or leverage the link cluster coupled operation. The procedures are divided into three phases in some examples: discovery, establishing, and termination. First, the devices discover the relevant links or the link cluster in the discovery phase. In the second phase, the devices establish the connection via a link. In the third phase, the devices terminate the link or the link cluster. The methods described herein may be based on over the air packet exchange supported by HCI and generic attribute profile (GATT). The methods described herein may also include some procedures for notification, selection, and negotiation of the connection parameters of any of the links within the link cluster.

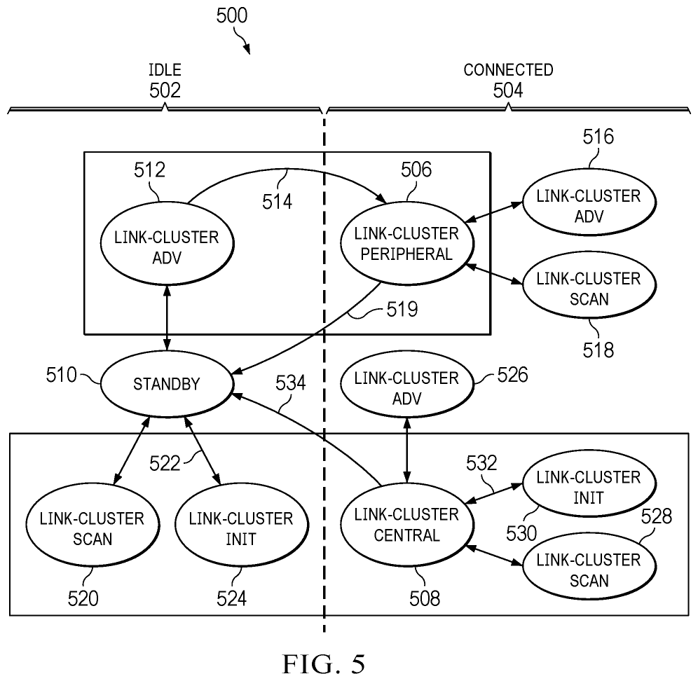

FIG. 5 is a block diagram of a state machine 500 for a BLE device in accordance with various examples herein. Although state machine 500 is described as a BLE device, a BLUETOOTH device or any other communication device may be configured to implement state machine 500. State machine 500 shows an idle side 502 and a connected side 504. In this example, the BLE device could operate as a link cluster peripheral device or a link cluster central device, depending on the BLE device's actions. The BLE device may begin in a standby state 510. The BLE device can move into an advertisement (ADV) state 512 by broadcasting an advertisement signal. The ADV may include advertisement of connection parameters for a link within a link cluster. After the ADV state 512, the BLE device may establish a connection 514 and move to the link cluster peripheral state 506 on the connected side 504. In the link cluster peripheral state, the BLE device may advertise again at state 516 or SCAN at state 518. The BLE device may advertise again at state 516 to connect to another device, via creating another link within the link cluster. In another example, the BLE device may SCAN at state 518 for an advertisement from another device. The BLE device may also terminate a link via termination 519 and return to the standby state 510.

In another example, the BLE device may move from the standby state 510 to a SCAN state 520 and initiate a SCAN. If the SCAN successfully captures an ADV signal from another device, the BLE device can initialize (INIT) a connection 522 to a link cluster initialization state 524. The BLE device in the initialization state 524 may initialize a link cluster central 508 on the connected side 504. The BLE device then operates as a central device. In this state, BLE device may advertise at state 526, SCAN at state 528, or initialize another link cluster at 530 via connection 532. The BLE device may also terminate a connection via termination 534 and return to the standby state 510.

FIG. 5 shows how a BLE device may advertise or scan for links or link cluster connections in some examples. The BLE device may also act as a central or a peripheral device depending on the state of the BLE device. Other states or flows between states may be performed in other examples.

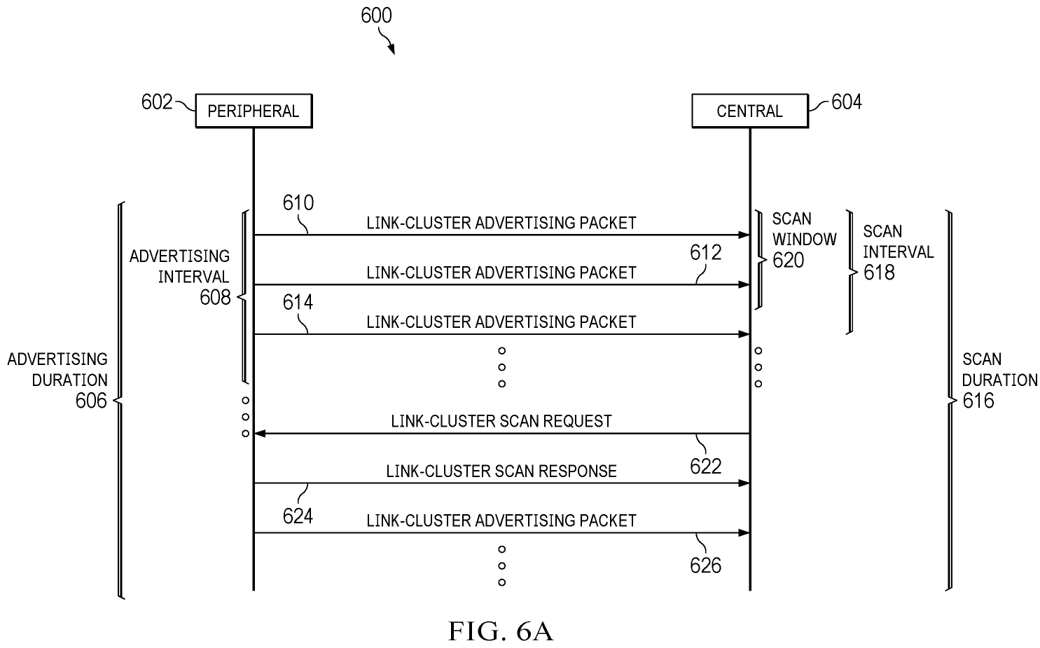

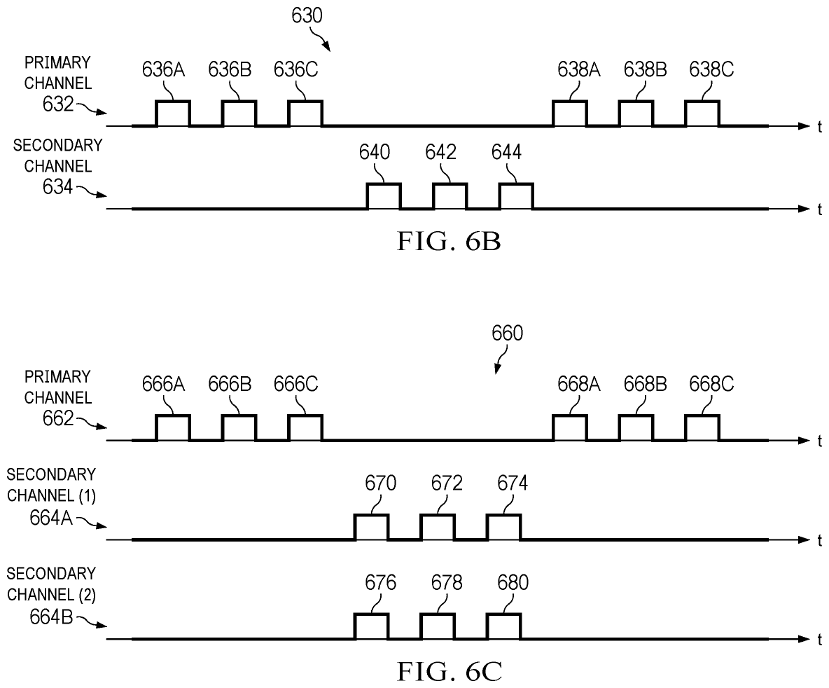

FIG. 6A is a discovery phase flow 600 for link clusters in accordance with various examples herein. In discovery phase flow 600, a peripheral device 602 (e.g., a broadcaster device) and a central device 604 (e.g., a scanner device) are shown as one example. In the discovery phase flow 600, the devices exchange packets to discover the link functionality, configuration, proposed or preferred joining methodology, etc., for a link cluster. The device functionality may include the features that are supported by the various devices. The features may include the connection parameters described herein. The configurations may include a default or preferred configuration of connection parameters in some examples.

Peripheral device 602 (e.g., a broadcaster) may enter an advertising duration 606, which includes an advertising interval 608. The advertising state is described above with respect to FIG. 5. During the advertising interval 608, peripheral device 602 may broadcast advertising packets 610, 612, and 614 for a link within a link cluster to central device 604 (or to other devices). Peripheral device 602 may wake to send an advertising packet, and then enter a sleep state before waking to send another advertising packet in some examples. The advertising packets may include any information regarding the link or the link cluster, including channel sets, connection event starting point (anchor point), connection duration, power level, MCS, or any other connection parameters. The connection parameters may include the capabilities, limitations, and/or preferences of a device or a link within a link cluster.

Central device 604 (e.g., a scanner) may be in a scan state that has a scan duration 616. The scan duration 616 has a scan interval 618, which includes a scan window 620. During the scan duration 616, central device 604 may receive the advertising packets 610, 612, and/or 614 for the link within the link cluster from peripheral device 602. Responsive to receiving an advertising packet 610, 612, or 614, central device 604 may send a link cluster join or coordination (e.g., scan) request 622 to peripheral device 602. With a link cluster join request, the central device 604 may request to establish a link with the peripheral device 602 using the connection parameters in the advertising packet or packets. With a link cluster coordination request, the central device 604 may transmit a change or propose a change to one or more connection parameters in the advertising packet or packets. Peripheral device 602 can then send a link cluster join or coordination (e.g., scan) response 624 to central device 604. The link cluster join or coordination response 624 may establish a link in a link cluster or negotiate a link in a link cluster between peripheral device 602 and central device 604 using the negotiated connection parameters. The negotiation and coordination process may include any number of steps or transmissions between the devices. Peripheral device 602 may then continue advertising by broadcasting another advertising packet or packets 626 for a link within a link cluster, including any connection parameters. Peripheral device 602 may also connect to other central devices in some examples. In some examples, the broadcaster device may offer a choice of connection parameters for a scanner device to choose from. As described above, the devices may coordinate channel sets, start and stop times of connection events, and connection parameters for the connection events, such as power and MCS.

Although FIG. 6 is described with respect to joining or coordinating a link, other types of communication by a scanner are possible. For example, a scanner can respond to a broadcast by requesting to join a new link with the broadcaster. As another example, the scanner can also coordinate an active or existing link or request to suspend an active or existing link. A request to suspend may indicate the timing for suspension, or the request may indicate that the suspension should occur immediately. The request to suspend may include a suspend expiration time, or may include a request to suspend a link or links without an expiration time. The request to suspend may include one or more suspend criteria in some examples. As a further example, the scanner can send a request to the broadcaster requesting the termination of an existing link. A request to terminate may indicate the timing for termination, or the request may indicate that the termination should occur immediately. The request to terminate may include one or more termination criteria in some examples. Another example is that the scanner can send a request to the broadcaster requesting to resume a suspended link.

FIGS. 6B and 6C are two examples of link cluster discovery signaling in accordance with various examples herein. FIG. 6B is a classic option, with a primary and a secondary channel. FIG. 6C is a duplicated secondary option, with one primary and two secondary channels. FIGS. 6B and 6C show channels during an example advertising procedure between a broadcaster device and a scanner device as described above.

FIG. 6B includes two timing diagrams 630. A first timing diagram represents a primary channel 632, and a second timing diagram represents a secondary channel 634. On primary channel 632, an advertising event occurs that includes advertising packets 636A, 636B, 636C, 638A, 638B, and 638C. Any number of advertising packets may be included in an advertising event. The advertising event may include information such as connection parameters for links within a link cluster. The advertising event may be broadcast by a broadcaster device as described above with respect to FIG. 6A.

After the advertising event, packets may be transmitted on secondary channel 634. Packet 640 on secondary channel 634 is an auxiliary advertising indication with link cluster information. Packet 642 on secondary channel may be a scan (join/coordination/termination) request with link cluster information. Packet 642 may be transmitted from a scanner device to a broadcaster device. Packet 644 on secondary channel 634 is a scan response with link cluster information, which may be a join or coordination response. Packet 644 may be transmitted from the broadcaster device to a scanner device.

On primary channel 632, another advertising event may occur that includes advertising packets 638A, 638B, and 638C. After this advertising event, packets such as packets 640, 642, and 644 may be transmitted again on secondary channel 634.

FIG. 6C includes three timing diagrams 660. A first timing diagram represents a primary channel 662, a second timing diagram represents a secondary channel 664A, and a third timing diagram represents a duplicated secondary channel 664B. On primary channel 662, an advertising event occurs that includes advertising packets 666A, 666B, 666C, 668A, 668B, and 668C. Any number of advertising packets may be included in an advertising event. The advertising event may include information such as connection parameters for links within a link cluster. The advertising event may be broadcast by a broadcaster device as described above with respect to FIG. 6A.

After the advertising event, duplicated packets may be transmitted on both secondary channels 664A and 664B. The duplicated packet 670 on secondary channel 664A and packet 676 on secondary channel 664B are an auxiliary advertising indication with link cluster information. The duplicated packet 672 on secondary channel 664A and packet 678 on secondary channel 664B are a scan request with link cluster information, which may be a join or coordination request, or any of the other possible scanner responses, as described above with respect to FIG. 6A. The duplicated packets 672 and 678 may be transmitted from a scanner device to a broadcaster device. The duplicated packet 674 on secondary channel 664A and packet 680 on secondary channel 664B are a scan response with link cluster information, which may be a join or coordination response. Packets 674 and 680 may be transmitted from the broadcaster device to a scanner device.

On primary channel 662, another advertising event may occur that includes advertising packets 668A, 668B, and 668C. After this advertising event, the scanner may transmit packets on the secondary channels 664A and 664B similar to the packets 670, 672, 674, 676, 678, and 680 previously transmitted on these channels.

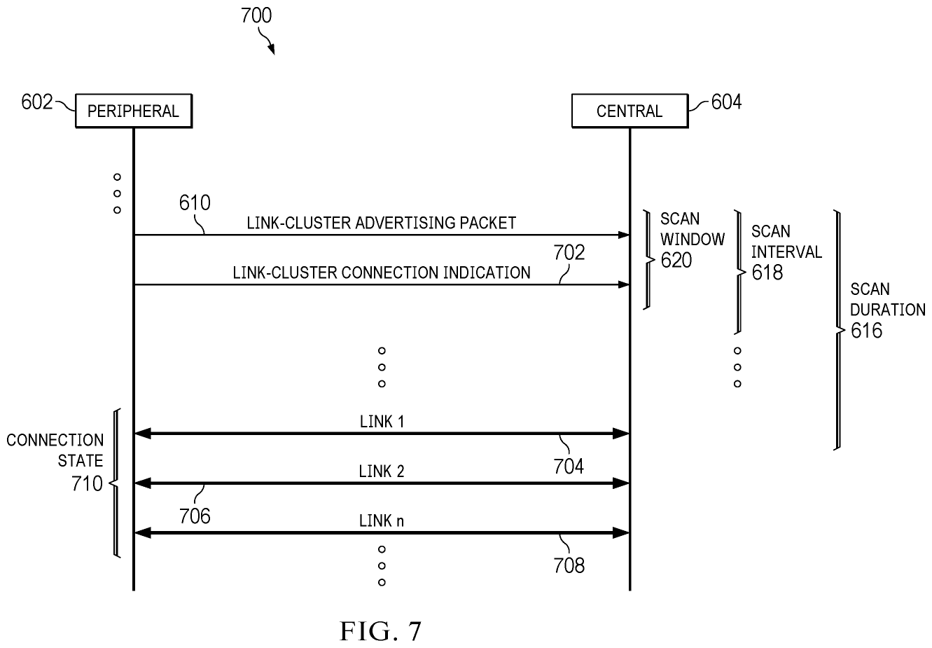

FIG. 7 is a connecting and termination phase flow 700 for links in a link cluster in accordance with various examples herein. In connecting and termination phase flow 700, peripheral device 602 (e.g., broadcaster device) and central device 604 (e.g., scanner device) are shown as one example. In the connecting and termination phase flow 700, the devices may set up a coordinated cluster of individual links between one another for communication. The devices may connect via multiple links with one advertisement and indication process. Also, the devices may terminate one or more of the links within the link cluster.

Flow 700 may include a link cluster advertising packet 610 broadcast from peripheral device 602 (e.g., broadcaster) to central device 604 (e.g., scanner). Responsive to receiving the link cluster advertising packet or packets 601, central device 604 may transmit a link cluster connection indication 702 to establish one or more links within the link cluster. The link cluster may include link 1 704, link 2 706, and link N 708 between peripheral device 602 and central device 604. Peripheral device 602 and central device 604 may enter a connection state 710, where the devices communicate with one another using the links within the link cluster. Any of the links of the link cluster may also be terminated individually or collectively. Links 704, 706, and 708 may each have different channel sets or other different connection parameters as described herein. The communication on links 704, 706, and 708 may overlap in time because of the frequency separation.

In examples herein, BLE messages between devices may include coupled coordinated parameters. The coupled coordinated parameters are useful for notifying, selecting, and negotiating the connection parameters of a specific link or several coupled links within a link cluster. The BLE messages may be expanded to include this information. The procedures for coordinating the coupled parameters includes advertising the connection parameters, such as the number of supported links, the frequency or bandwidth of the links, physical (PHY) parameters of link(s) (e.g., rate, power, etc.), a channel map and channel selection, encryption parameters, modem characteristics, packet level limitations, packet duration limitations, connection event limitations, power management limitations MCS, duration, connection event starting point. etc. The procedures also include establishing the connection parameters. The procedures may include a channel map advertisement. For example, only certain channels may be enabled for advertisements rather than all advertising channels. The channel map advertisement may be useful for coordinating frequency, power, the duration of the connection interval, etc. The procedures may also include encryption establishment. Each link in a link cluster may have a unique key used for encryption. Credentials may also be established for the connecting devices. Supported features may be advertised as well. Also, the coupled coordinated parameters may include termination conditions.

In some examples the packet exchange is supported over the HCI interface and based on GATT level signaling. A host may manage a link cluster. Coordinated discovery, establishment, and termination flows are defined for controlling coupled links within a link cluster between a GATT client and a GATT server. The Generic Access Profile (GAP) controls connections and advertising in BLUETOOTH, and determines how two devices can interact with one another. GAP defines the central and peripheral roles for devices. GAP describes the advertising and scan response processes, as described above with respect to FIG. 6A. GATT defines the way BLE devices transfer data back and forth. GATT uses a generic data protocol called the Attribute Protocol (ATT), which stores services, characteristics, and other related data in a lookup table using 16-bit IDs. GATT is used after a connection is established between two devices using GAP.

GATT uses a server/client relationship. The GATT server holds the ATT lookup data and service and characteristic definitions, and the GATT client sends requests to this server. All transactions are started by the main device, the GATT client, which receives responses from the secondary device, the GATT server. In one example, the peripheral device is the GATT server and the central device is the GATT client. In other examples, the peripheral device may be the GATT client and the central device may be the GATT server, depending on which direction data is transferred between the devices.

In examples herein, GATT may be useful for controlling links within a link cluster between a GATT client and a GATT server. Process flows described herein support link cluster service discovery, GATT link cluster client requests and server responses, GATT indications or notifications from client to server, and data transfer between devices. In one example, the process iterates through all available link cluster services in a GATT database, and an event is generated for each link cluster service discovered. In some examples, server-initiated link cluster updates may be sent from the GATT server to the client without the client requesting the update. Notifications may include the identifier of the link cluster characteristic, the link cluster value, and/or connection parameters. GATT messaging may be performed at the application layer or at the link layer via HCI in some examples.

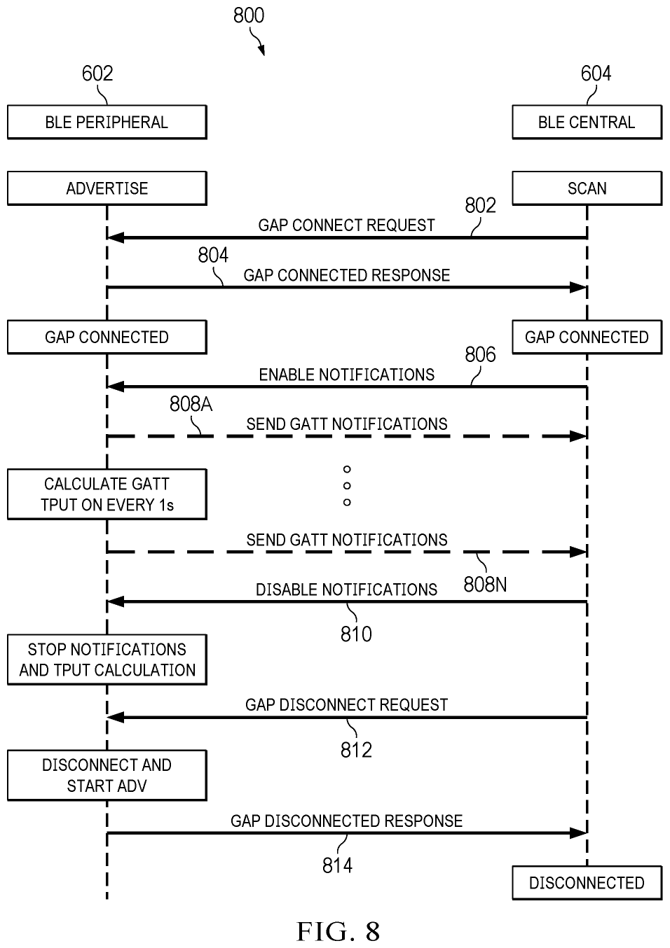

FIG. 8 is a GATT flow 800 for one or more links in a link cluster in accordance with various examples herein. GATT flow 800 includes a peripheral device 602 communicating with a central device 604. Central device 604 sends a GAP connection request 802, and peripheral device 602 sends a GAP connected response 804. Peripheral device 602 and central device 604 are GAP connected after GAP connected response 804.

Central device 604 sends an enable notifications message 806 to peripheral device 602. The message 806 enables GATT notifications between the two devices. Peripheral device 602 may send GATT notifications 808A to 808N, where any number N of GATT notifications may be sent. The GATT notifications may include link cluster information. These GATT notifications 808A to 808N may be sent without the client (e.g., central device 604) requesting the notifications. As shown in FIG. 8, GATT throughput may also be calculated by peripheral device 602.

Central device 604 may send a disable notifications message 810 to peripheral device 602. Responsive to receiving the message 810, peripheral device 602 stops notifications and the throughput calculation. In some examples, central device 604 may then send a GAP disconnect request 812 to peripheral device 602. Responsive to receiving the GAP disconnect request, peripheral device 602 disconnects and may start advertising to other devices. Peripheral device 602 may also send a gap disconnected response 814 to central device 604, completing the GAP disconnect process.

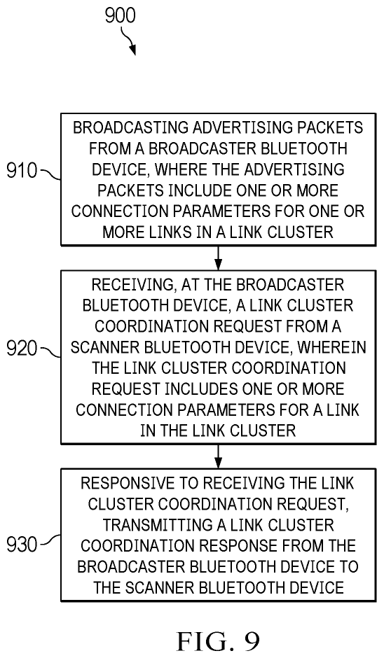

FIG. 9 is a flow diagram of a method 900 for establishing a link cluster in accordance with various examples herein. The steps of method 900 may be performed in any suitable order. The hardware components described above with respect to FIGS. 1-4C may perform method 900 in some examples.

Method 900 begins at 910, where a broadcaster BLUETOOTH device broadcasts advertising packets, and where the advertising packets include one or more connection parameters for one or more links in a link cluster. The broadcast of an advertising packet is described above with respect to FIGS. 5-7.

Method 900 continues at 920, where the broadcaster BLUETOOTH device receives a link cluster coordination request from a scanner BLUETOOTH device. The link cluster coordination request includes one or more connection parameters for a link in the link cluster. The connection parameters may include channel sets, a connection event starting point (anchor point), connection duration, power level, MCS, connection interval anchor time, or any other connection parameters. The scanner BLUETOOTH device may accept the connection parameters for the link, or may propose other connection parameters in some examples. In other examples, the scanner BLUETOOTH device may send a join request accepting the connection parameters.

Method 900 continues at 930, where, responsive to receiving the link cluster coordination request, the broadcaster BLUETOOTH device transmits a link cluster coordination response from the broadcaster BLUETOOTH device to the scanner BLUETOOTH device. The link cluster coordination response may be an optional step that is not performed in every example. Thus, the method 900 may end with the link cluster coordination request received at 920. In an example, the devices may be connected via a link within the link cluster at this time. The devices may then communicate with one another using a link or links within the link cluster as described herein. In other examples, after transmitting the coordination response, the broadcaster BLUETOOTH device may be configured to send another broadcast to attempt to form a link with another scanner. In other examples, after transmitting the coordination response, the broadcaster BLUETOOTH device may be configured to communicate with other devices in the link cluster. In other examples, after receiving the coordination response, the scanner BLUETOOTH device may be configured to scan for a broadcast from another broadcaster. In other examples, after receiving the coordination response, the scanner BLUETOOTH device may be configured to communicate with other devices in the link cluster.

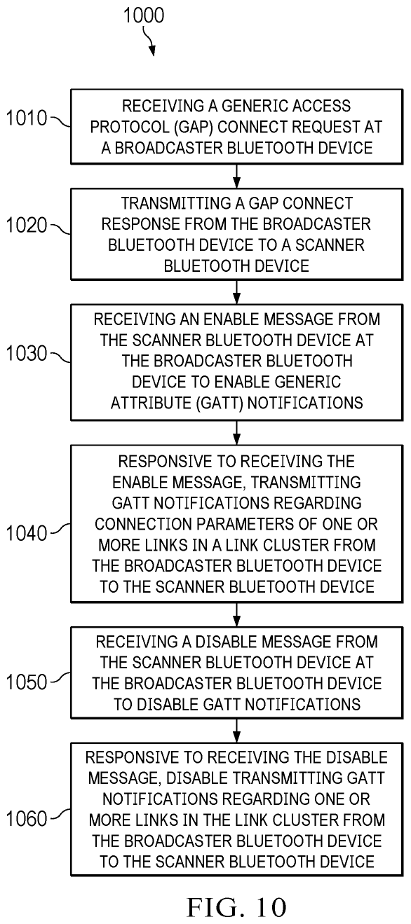

FIG. 10 is a flow diagram of a method 1000 for controlling a link cluster with GATT in accordance with various examples herein. The steps of method 1000 may be performed in any suitable order. The hardware components described above with respect to FIGS. 1-4C may perform method 1000 in some examples.

Method 1000 begins at 1010, where a broadcaster BLUETOOTH device receives a GAP connect request. FIG. 8 shows one example of this request. The broadcaster BLUETOOTH device may receive the GAP connect request from a scanner BLUETOOTH device.

Method 1000 continues at 1020, where the broadcaster BLUETOOTH device transmits a GAP connect response from the broadcaster BLUETOOTH device to a scanner BLUETOOTH device.

Method 1000 continues at 1030, where the broadcaster BLUETOOTH device receives an enable message from the scanner BLUETOOTH device to enable GATT notifications.

Method 1000 continues at 1040, where, responsive to receiving the enable message, the broadcaster BLUETOOTH device transmits GATT notifications regarding connection parameters of one or more links in a link cluster from the broadcaster BLUETOOTH device to the scanner BLUETOOTH device. The broadcaster BLUETOOTH device and the scanner BLUETOOTH device may be configured to communicate over the one or more links based on the connection parameters indicated in the GATT notifications.

Method 1000 continues at 1050, where the broadcaster BLUETOOTH device receives a disable message from the scanner BLUETOOTH device to disable GATT notifications.

Method 1000 continues at 1060, where, responsive to receiving the disable message, the broadcaster BLUETOOTH device disables transmitting GATT notifications regarding one or more links in the link cluster from the broadcaster BLUETOOTH device to the scanner BLUETOOTH device. After 1060, the broadcaster BLUETOOTH device may begin advertising again to scanner BLUETOOTH devices, as described herein.

Examples herein also provide link cluster control and management. Link clusters may perform unicast data exchange in one example. This link cluster control and management for unicast data exchange may support unicast link cluster operation profile modification and/or unicast link cluster feedback and reporting for one or multiple links within a link cluster.

The BLE link cluster control and management procedures described herein for data exchange may be issued based on over-the-air signal exchange (in the case where the link cluster split/aggregation point is at the BLE PHY/modem level) or over HCI single exchange flow (in the case where the split/aggregation point is the BLE controller level) or a combination of both between the link layers of the devices.

The BLE link cluster control and management procedures expand on independent unaware BLE signaling to support link cluster functionality applied at one or more coupled links within a link cluster. In some examples, this signaling is expanded by adding extra link cluster signaling entities, such as multi-link elements or a field. In some examples, to reduce overhead and connection time and responsiveness, one or more of the devices may be configured to perform the link cluster signaling process on only a preferred single link.

In some examples herein, the BLE link cluster link layer defines coordination procedures for controlling coupled links within a link cluster. These coordination procedures are useful for setting or updating the depended parameters of specific links, or of several coupled links, within a link cluster. A number of coordination procedures are described herein. The coordination procedures may include the devices performing a link connection parameter modification request procedure. To perform this procedure, one of the devices may request a specific link or links within a link cluster for modifying or setting a connection parameter. The coordination procedures may include a link connection parameter update procedure to update the link cluster parameters or execute an update procedure. The coordination procedures may include a link PHY parameters modification request procedure to request to modify or set PHY parameters of a link. The coordination procedures may include a link PHY parameters modification update procedure to update PHY parameters of a link or link cluster or execute an update procedure. The coordination procedures may include a synchronized link cluster channel map update procedure to update link cluster channel maps and participate in frequency-hopping link cluster synchronized channel selection. The coordination procedures may also include a link cluster encryption parameters modification procedure to update link cluster encryption control. The coordination procedures may include a feature modification procedure to activate or deactivate supported features of a link cluster. Any of the devices in a link cluster may be configured to perform these procedures.

The coordination procedures may include a link cluster status reporting procedure to report status of a link or links within a link cluster. As an example, the multi-link signaling entities may exchange status information regarding a number of supported links, the PHY characteristics of a link (rate, power, etc.), the transmission operation mode (asynchronous, synchronous, synchronous duplicate, etc.), or other per-link information. One or more of the devices in a link cluster may be configured to perform a status reporting procedure to report the status of any of the links in the link cluster. For example, any of the devices in the link cluster may be configured to exchange information regarding the number of supported links, the rate or power of any of the links, the operation characteristics of any of the links, multi-link transmission operation (e.g., asynchronous or synchronous operation), or any other link information. A first device in the link cluster can send a request to a second device in the link cluster requesting status information, and the second device can respond to the request with the requested status information. Additionally or alternatively, the second device may be configured to report the status information to the first device at regular intervals or based on a schedule.

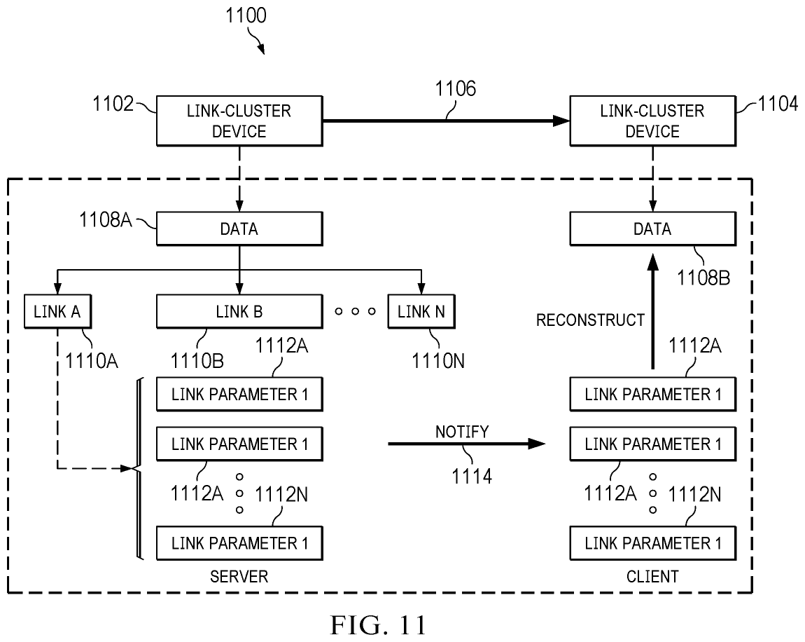

FIG. 11 is a procedure flow 1100 for link cluster coordination in accordance with various examples herein. FIG. 11 shows a procedure flow 1100 for a link cluster device 1102 and a link cluster device 1104, connected by a link cluster 1106. Link cluster device 1102 may be a server in one example, while link cluster device 1104 is a client. The link cluster device 1102 may store data 1108A. Data 1108A may include data regarding link A 1110A, link B 1110B, . . . link N 1110N (collectively, links 1110). Links 1110 may make up link cluster 1106 in one example. Each link 1110 may have a collection of one or more link parameters (e.g., connection parameters). As an example, procedure flow 1100 shows link parameter 1 1112A link parameter 2 1112B, . . . link parameter N 1112N (collectively, link parameters 1112). Link B 1110B and other links 1110 may have their own collection of link parameters 1112, although only one collection of link parameters 1112 is shown in FIG. 11.

In procedure flow 1100, link cluster device 1102 may send a notification 1114 to link cluster device 1104 to notify link cluster device 1104 of the link parameters 1112 for a link or links 1110. Link cluster device 1104 may use the link parameters 1112 to reconstruct the data 1108A stored at link cluster device 1102 and create data 1108B stored at link cluster device 1104, which may include the link parameters 1112 for the various links 1110. Therefore, link cluster device 1104 may be notified of changes to the link parameters 1112 with procedure flow 1100.

In examples described herein, the devices in a link cluster can perform the link cluster signaling exchanges described herein over at least one link in the link cluster. The link cluster signaling changes may modify operation settings (such as: link air access operation characteristics, link modem and media access control (MAC) characteristics, link power management, etc., at the packet and the connection interval level) of one (or more) coupled links within the link cluster. The link cluster signaling may enable devices to change transmission modes, such as a synchronized mode, a synchronized duplicate mode, or a joint asynchronized mode as described above. A synchronized mode transmits synchronized packets on separate links. A synchronized duplicate mode transmits duplicate packets on separate links in a synchronized manner. A joint asynchronized mode transmits packets over multiple available links, but copies of packets are not sent.

One example power management coordination procedure supported by link cluster signaling is a power save state. A device as described herein may operate in two modes: active mode and power save mode. In the active mode, the device is always awake and can transmit and receive frames during a sheltered connection interval. In the power save mode, the device can suspend one or more of the links from time to time. If the links are suspended, the device may be connected temporarily via a single link within the link cluster. The single link may be an anchor link, which is a link that controls other links within the link cluster and keeps the network alive in some examples. The device may then resume the other links via link cluster signaling with the anchor link to re-enter the active mode.

Depending on the traffic conditions, channel conditions, and interference at different links and different frequencies, the power management coordination procedure may use link cluster signaling for parameter modification for one or more links within the link cluster, or to temporarily suspend links within the link cluster that will not be used for data transmission. The power management coordination procedure may therefore reduce power consumption in some examples.

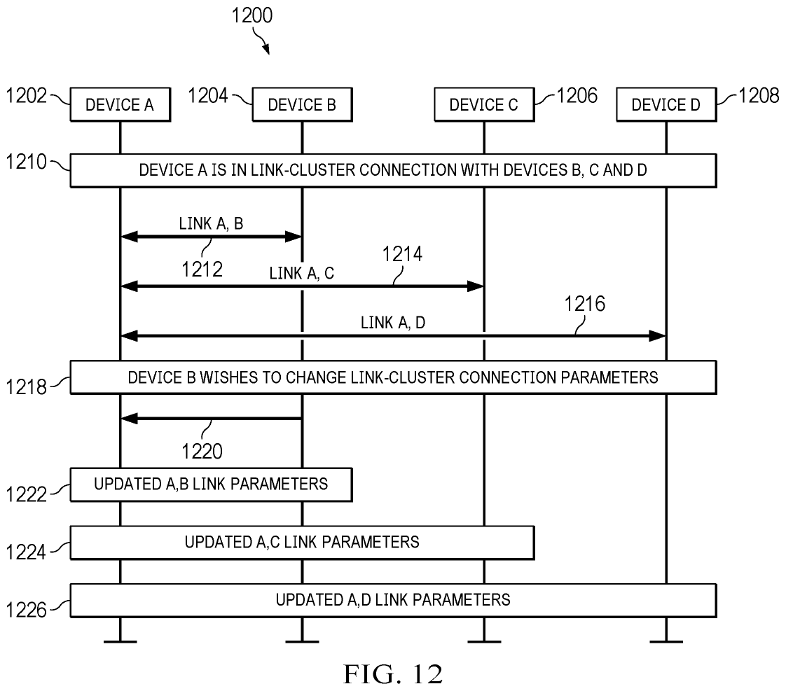

FIG. 12 is a procedure flow 1200 for link cluster control and management in accordance with various examples herein. FIG. 12 shows a procedure flow 1200 that includes device A 1202, device B 1204, device C 1206, and device D 1208. At 1210, device A 1202 is in a link cluster connection with devices B 1204, C 1206, and D 1208. Link A, B 1212 connects device A 1202 to device B 1204. Link A, C 1214 connects device A 1202 to device C 1206. Link A, D 1216 connects device A 1202 to device D 1208. At 1218, device B 1204 wishes to change one or more link cluster connection parameters between device B 1204 and device A 1202. Device B 1204 may send a request 1220 to device A 1202. The request 1220 may concern any characteristic, such as an operation setting, MAC characteristic, power management, operation mode, links within the link cluster, transmission rate, transmission power, connection duration, MCS limitations, anchor point, frequency of a connection event, etc. The devices described herein may also share feedback regarding any of the characteristics described above. The feedback may be used by any of the devices for managing the operation of one or more links within the link cluster. The request 1220 may also request changing from duplicate mode to joint mode or vice versa in one example.

Responsive to the request 1220, device A 1202 may update the link connection parameters between device A 1202 and device B 1204 at 1222. Device A 1202 may also update the link connection parameters for device C 1206 at 1224, and/or update the link connection parameters for device D 1208 at 1226.

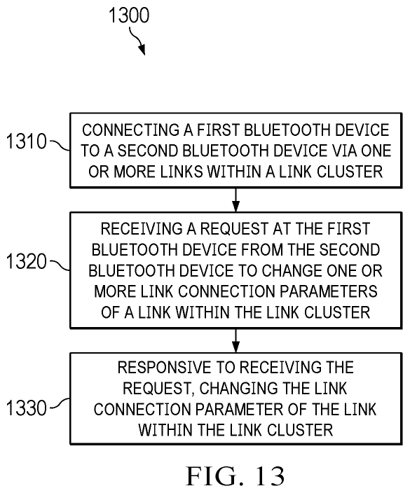

FIG. 13 is a flow diagram of a method 1300 for managing link cluster connection parameters in accordance with various examples herein. The steps of method 1300 may be performed in any suitable order. The hardware components described above with respect to FIGS. 1-4C may perform method 1300 in some examples.

Method 1300 begins at 1310, where a first BLUETOOTH device connects to a second BLUETOOTH device via one or more links within a link cluster. The devices may be connected using the procedures described herein. In other examples, more than two BLUETOOTH devices may be connected.

Method 1300 continues at 1320, where the first BLUETOOTH device receives a request from the second BLUETOOTH device to change one or more link connection parameters of a link within the link cluster. FIG. 12 includes one example of a request.

Method 1300 continues at 1330, where, responsive to receiving the request, the first BLUETOOTH device changing the link connection parameter of the link within the link cluster. The link connection parameter may be any of the connection parameters described in the various examples herein. In other examples, other BLUETOOTH devices may also update link cluster connection parameters for one or more link within their respective link clusters.

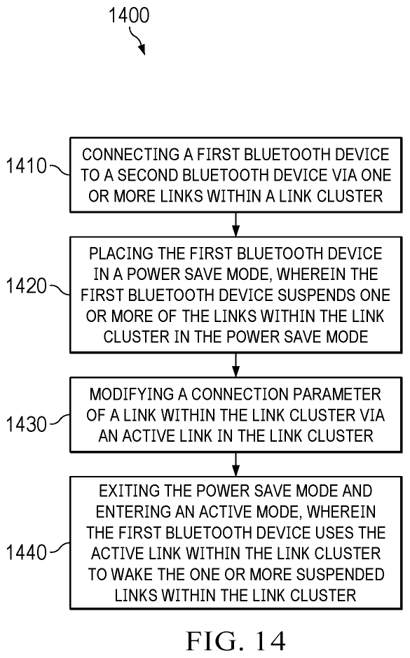

FIG. 14 is a flow diagram of a method 1400 for power management in a link cluster in accordance with various examples herein. The steps of method 1400 may be performed in any suitable order. The hardware components described above with respect to FIGS. 1-4C may perform method 1400 in some examples.

Method 1400 begins at 1410, where a first BLUETOOTH device connects to a second BLUETOOTH via one or more links within a link cluster. The devices may connect to one another via the process described herein, such as in FIGS. 6A-6C and 7.

Method 1400 continues at 1420, where the first BLUETOOTH device enters a power save mode. In the power save mode, the first BLUETOOTH device suspends one or more of the links within the link cluster. The links may be suspended to save power or for other reasons. As an example, if a link will not be used for data transmission, the link may be suspended. In some examples, all but one link is suspended, and the single non-suspended link is used to keep the network alive.

Method 1400 continues at 1430, where the first BLUETOOTH device modifies a link connection parameter of a link within the link cluster via an active link in the link cluster. In one example, the first BLUETOOTH device may send a request to another device to modify a connection parameter, or may modify the link connection parameter and notify other BLUETOOTH devices.

Method 1400 continues at 1440, where the first BLUETOOTH device exits the power save mode and enters an active mode, where the first BLUETOOTH device uses the active link within the link cluster to wake the one or more suspended links within the link cluster. For example, the first BLUETOOTH device may be configured to send a message over the active link to a second BLUETOOTH device to wake a suspended link. The suspended link may be a link between the first and second BLUETOOTH devices, or the suspended link may be a link between the second BLUETOOTH device and a third BLUETOOTH device. The suspended links may be made active upon entering the active mode.

In examples herein, link clusters allow a BLE system to optimize power consumption, latency reduction, and increase system level throughput. Over the air signal exchange or signal exchange over HCI may be useful for discovering the link cluster device functionality, understanding a device's preferred or default configuration, and transmitting a proposed or preferred link cluster joining methodology. Links may be established and/or terminated using the same techniques in some examples. Signaling may be performed on a single link in the link cluster in some examples. Coordination procedures for links within link clusters may include parameter advertisement, parameter establishment, channel map advertisement, encryption establishment, common feature advertisement, and termination. Clusters of links may coordinate and leverage the link cluster operations. Link clusters may synchronize connection parameters of links in some examples. A single link layer may control the link cluster in some examples.

The term “couple” is used throughout the specification. The term may cover connections, communications, or signal paths that enable a functional relationship consistent with this description. For example, if device A generates a signal to control device B to perform an action, in a first example device A is coupled to device B, or in a second example device A is coupled to device B through intervening component C if intervening component C does not substantially alter the functional relationship between device A and device B such that device B is controlled by device A via the control signal generated by device A.

A device that is “configured to” perform a task or function may be configured (e.g., programmed and/or hardwired) at a time of manufacturing by a manufacturer to perform the function and/or may be configurable (or re-configurable) by a user after manufacturing to perform the function and/or other additional or alternative functions. The configuring may be through firmware and/or software programming of the device, through a construction and/or layout of hardware components and interconnections of the device, or a combination thereof.

Unless otherwise stated, “about,” “approximately,” or “substantially” preceding a value means +/−10 percent of the stated value. Modifications are possible in the described examples, and other examples are possible within the scope of the claims.

What is claimed is:

1. A method, comprising:
connecting a first BLUETOOTH device to a second BLUETOOTH device via one or more links within a link cluster;
receiving a request at the first BLUETOOTH device from the second BLUETOOTH device to change one or more link connection parameters of a link within the link cluster; and
responsive to receiving the request, changing the link connection parameter of the link within the link cluster.

2. The method of claim 1, wherein the link is a first link, and wherein the first BLUETOOTH device is connected to a third BLUETOOTH device via a second link within the link cluster, and the method further comprises:
responsive to receiving the request, changing a link connection parameter of the second link within the link cluster between the first BLUETOOTH device and the third BLUETOOTH device.

3. The method of claim 1, wherein the link connection parameter of the link within the link cluster includes a physical (PHY) parameter.

4. The method of claim 3, wherein the PHY parameter of the link within the link cluster includes transmit power limitations.

5. The method of claim 3, wherein the PHY parameter of the link within the link cluster includes packet duration limitations.

6. The method of claim 3, wherein the PHY parameter of the link within the link cluster includes a modulation coding scheme limitation.

7. The method of claim 1, wherein the request is a first request, and wherein the link is a first link, the method further comprising:
receiving a second request at the first BLUETOOTH device from the second BLUETOOTH device for a status of one or more link connection parameters of the second link within the link cluster.

8. The method of claim 7, wherein the status includes a PHY characteristic of the second link within the link cluster.

9. The method of claim 7, wherein the status includes a number of links within the link cluster.

10. The method of claim 7, wherein the status includes a transmission mode for the second link within the link cluster.

11. The method of claim 1, wherein the connection parameter of the link within the link cluster includes a duration of a connection interval.

12. The method of claim 1, wherein the connection parameter of the link within the link cluster includes a duration of a connection interval anchor time.

13. A method, comprising:
connecting a first BLUETOOTH device to a second BLUETOOTH device via one or more links within a link cluster;
placing the first BLUETOOTH device in a power save mode, wherein the first BLUETOOTH device suspends one or more of the links within the link cluster in the power save mode;
modifying a connection parameter of a link within the link cluster via an active link in the link cluster; and
exiting the power save mode and entering an active mode.

14. The method of claim 13, wherein the first BLUETOOTH device suspends one or more of the links in the power save mode responsive to traffic conditions within the link cluster.

15. The method of claim 13, wherein the first BLUETOOTH device suspends one or more of the links with a suspend expiration time.

16. The method of claim 13, wherein the link is a first link, and wherein the first BLUETOOTH device terminates a second link within the link cluster.

17. The method of claim 13, wherein the first BLUETOOTH device suspends all but one of the links in the link cluster in the power save mode.

18. The method of claim 13, wherein the first BLUETOOTH device is connected to the second BLUETOOTH device in a synchronous duplicate mode.

19. The method of claim 13, wherein the first BLUETOOTH device is connected to the second BLUETOOTH device in a joint asynchronous mode.

20. The method of claim 13, wherein the first BLUETOOTH device uses the active link within the link cluster to wake the one or more suspended links within the link cluster.
